(19) United States
(12) Patent Application Publication
(10) Pub. No.: US 2006/0260690 A1
(43) Pub. Date: Nov. 23, 2006

(54) Pressure regulator with reduced outlet pressure loss

(75) Inventors: Donald J. Winnike, Saint George, SC (US); William M. Gregg, Maryville, TN (US)

Correspondence Address: RATNERPRESTIA, P O BOX 980, VALLEY FORGE, PA, 19482-0980, US

(73) Assignee: ITT Industries, Inc. -Conoflow

(21) Appl. No.: 11/287,781

(22) Filed: Nov. 28, 2005

Related U.S. Application Data
(60) Provisional application No. 60/683,365, filed on May 20, 2005.

(51) Int. Cl. G05D 16/10

(52) U.S. Cl. 137/484.8

(57) ABSTRACT

A pressure regulator configured to reduce fluid flow droop is provided. The pressure regulator comprises a regulator housing having an inlet port, an outlet port and a fluid flow passage therebetween. A valve seat is positioned in the fluid flow passage and a valve plug cooperates with the valve seat to control the flow of a fluid through the fluid flow passage. A bypass plate retains the valve seat in the fluid flow passage, and separates the fluid flow passage from a sensing chamber. The bypass plate includes a flow aperture positioned in the flow passage and at least one aspirator that provides communication between the flow aperture and the sensing chamber. The flow aperture is configured to provide a low pressure region relative to the pressure in the fluid flow passage, wherein the aspirators are configured to communicate between the low pressure region and the sensing chamber.

This application claims priority of U.S. Provisional Patent Application Ser. No. 60/683,365 filed May 20, 2005.

### TECHNICAL FIELD

The present invention relates to pressure regulators, and more particularly, to a pressure regulator with reduced outlet pressure loss.

### BACKGROUND OF THE INVENTION

A pressure regulator controls gas flow from a high pressure source to a low pressure user device, while attempting to maintain a constant system pressure. Pressure regulators are utilized for various applications including, but not limited to, facilitating the delivery of high pressure, high purity gas or liquid to a user device such as a gas analyzer, laser, fuel cell or welding system. A fluctuation in gas pressure can, in some instances, result in an adverse effect on the performance of the device. Thus, it would be advantageous for a pressure regulator to maintain a constant system pressure.

To maintain constant system pressure, a pressure regulator should provide a constant outlet pressure. However, in practice, conventional pressure regulators commonly exhibit a phenomena called “fluid flow droop”, which yields an undesirable reduction in outlet pressure. More particularly, in regulators having a spring and diaphragm arrangement, droop is caused by at least two factors, namely, a change in the force exerted by the regulator spring over its travel and a change in the effective area of the diaphragm over its travel. These two factors, alone or in combination, lower the downstream control pressure.

Thus, there is a need to provide pressure regulators systems that compensate for or limit droop.

### SUMMARY OF THE INVENTION

According to an aspect of the invention, a pressure regulator configured to reduce fluid flow droop is provided. The pressure regulator comprises a regulator housing having an inlet port, an outlet port and a fluid flow passage therebetween. A valve seat is positioned in the fluid flow passage and a valve plug cooperates with the valve seat to control the flow of a fluid through the fluid flow passage. A bypass plate retains the valve seat in the fluid flow passage, and separates the fluid flow passage from a sensing chamber. The bypass plate includes a flow aperture positioned in the flow passage and at least one aspirator that provides communication between the flow aperture and the sensing chamber. The flow aperture is configured to provide a low pressure region relative to the pressure in the fluid flow passage, wherein the aspirators are configured to communicate between the low pressure region and the sensing chamber.

According to another aspect of the invention, the pressure regulator includes a bonnet mounted to the regulator housing, a non-linear spring positioned within the bonnet and a diaphragm positioned adjacent the spring and the valve plug. The spring urges the diaphragm to bias the valve plug toward an open position.

### BRIEF DESCRIPTION OF THE FIGURES

The invention is best understood from the following detailed description when read in connection with the accompanying drawing. Included in the drawing are the following figures:

FIG. 1A is a cross-sectional side view of an exemplary embodiment of a pressure regulator configured to limit flow droop according to an aspect of this invention;

FIG. 1B is an enlarged view of the top stage of the pressure regulator illustrated in FIG. 1A;

FIG. 2A is a top-side view of the exemplary flow bypass plate illustrated in FIG. 1A; and

FIG. 2B is a cross-sectional side view of the flow bypass plate illustrated in FIG. 2A.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

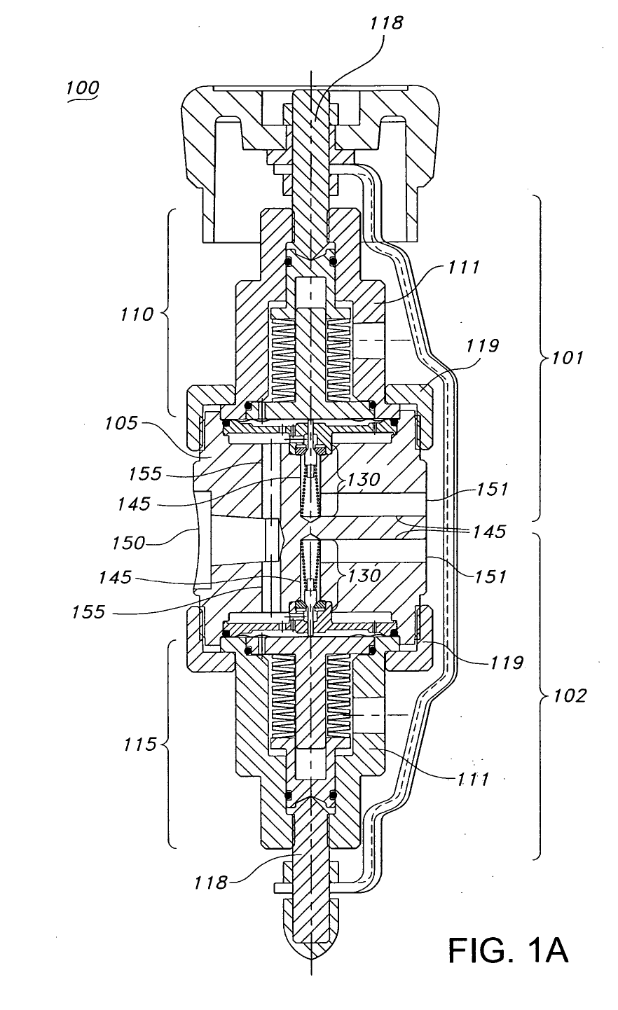

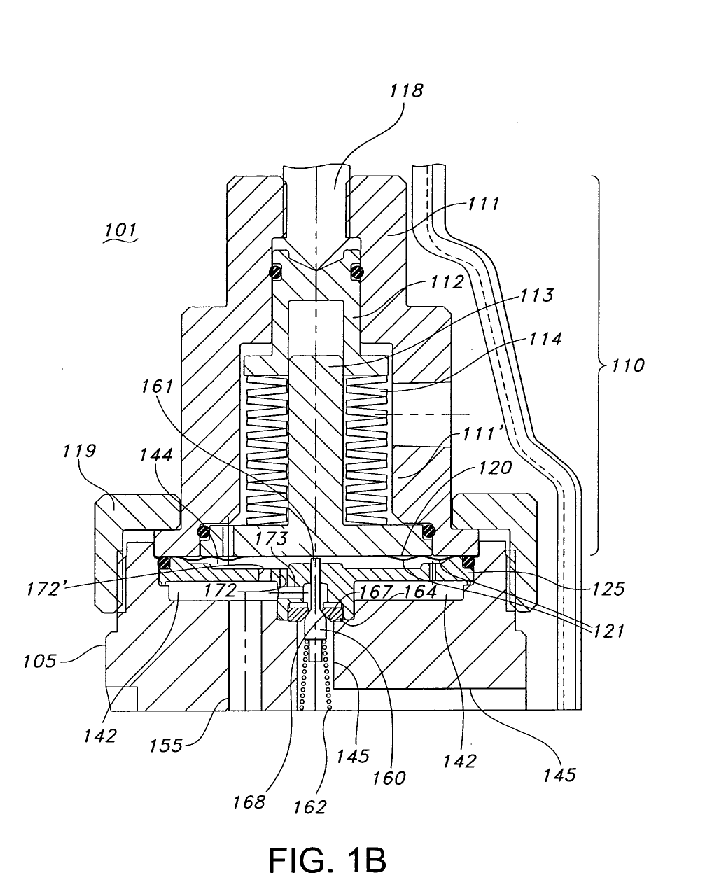

Referring specifically to the exemplary embodiment illustrated in FIGS. 1A and 1B, a parallel stage pressure regulator 100 comprising regulator stages 101 and 102 and configured to reduce droop is disclosed. It should be understood that the pressure regulator could be a single stage device having only one regulator stage 101 or 102. A parallel stage pressure regulator of the type disclosed herein facilitates the controlled delivery of gas from either of two high pressure sources (e.g. compressed gas tanks, cylinder banks, etc.) to a device operating at a lower pressure (e.g. gas analyzer, laser, fuel cell, welding system, etc.). A single stage device, of course, controls the delivery of gas from a single high pressure source.

The pressure regulator 100 comprises a valve body including central body member 105 and a pair of bonnets 111, 111 each of which is connected to the valve body by a threaded collar 119. One bonnet 111 is located on one end of the body member 105 and the other bonnet is located on an opposite end of the body member. Thus, one bonnet 111 is part of one regulator stage 101 and the other bonnet is part of the other regulator stage 102. Inasmuch as the regulator stages 101 and 102 are generally the same, only stage 101 will be described with the understanding that like reference numerals will be used for like structure in each stage and that any differences between the stages will be specifically pointed out hereinafter.

The body member 105 is generally cylindrical and includes a pair of inlet ports 151 formed in its cylindrical wall and an outlet port 150 also formed in its cylindrical wall. Each inlet port 151 communicates with one of the inlet passages 145, 145 so gas can be fed from either of two high pressure sources to one of the inlet passage 145. The outlet port 150 communicates with a pair of outlet passages 155, 155 each of which communicates with one of the inlet passages 145, 145 so that gas can flow from either high pressure source through one of the flow passages 145, 155 to the outlet port 150 and, thus, to a user device.

Between each of the passages 145 and 155, there is provided a valving assembly 130 each of which includes a valve plug 160 moveably carried in its associated inlet passage 145, a plug spring 162, and a valve seat 164 carried on the generally circular end face of the body member 105. One end of the plug spring 162 is grounded against a base surface of inlet passage 145 and the other end of the plug spring contacts a shoulder formed on the valve plug 160. A tapered surface 168 is formed intermediate the ends of valve plug 160 and the plug spring 162 biases the valve plug so that surface 168 is urged toward a conical surface 167 formed on the valve seat 164. In a closed position of valving assembly 130, surface 168 seats on surface 167. In an open position of valving assembly 130 mating surfaces 167 and 168 are separated by a circumferential gap. For reasons to be made clear hereinafter, the valve plug 160 is formed with a stem that extends beyond the valve seat 164 where it terminates in a bearing surface 161.

The bonnet 111 is formed with a stepped bore 111′ having its smaller diameter adjacent its free end and its largest diameter adjacent the body member 105. In the exemplary embodiment disclosed herein the bore 111′ is formed with four different diameters and these diameters increase in size from the free end to the end adjacent the body member 105. The smallest diameter is threaded and accommodates an adjusting screw 118 which bears against a spring retainer 112 that is slideably carried in one of the bore sections. One end of a spring 114 bears on the spring retainer 112 and the other end bears on a piston 113. The piston 113 is slidably carried in another section of the bore 111′. A diaphragm 120 is clamped between the outer edge of piston 113 and the radially outer edge of bypass plate 125 so that the plate is clamped on the generally circular end face of the body member 105 and which, in turn, clamps the valve seat 164 in place. The piston 113 bears on and urges the diaphragm 120 against the bearing surface 161 of the valve plug stem and, thus, biases the valving assembly 130 to an open position.

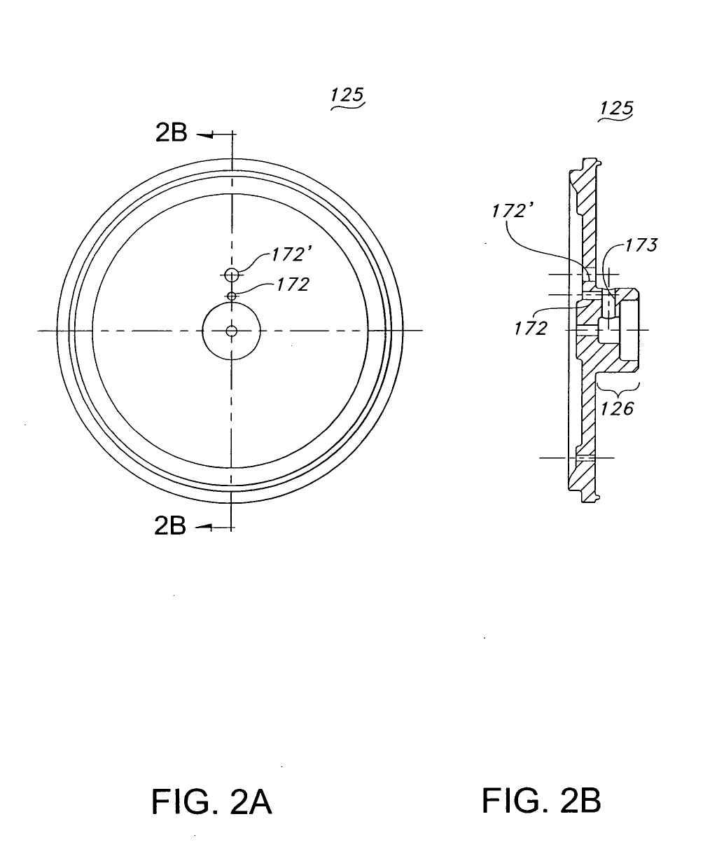

As shown in FIGS. 1A and 1B and as more clearly seen in FIGS. 2A and 2B, the bypass plate 125 is a generally circular disc member having a central opening through which the valve plug stem extends to its abutting relationship with the diaphragm 120. Extending from one surface of the disc member is a generally cylindrical hub 126 which bears on the valve seat 164 to clamp the valve seat in place on the body member 105. Extending radially through the hub 126 is a flow restricting passage 173 that communicates with the discharge side of the valve seat 164.

The circular disc portion of the bypass plate 125 divides the space between the diaphragm 120 and the end face of the body member 105 into a discharge chamber 142 and a sensing chamber 144. As best seen in FIG. 1B, the discharge chamber 142 is formed between the bypass plate 125 and the valving assembly 130 and it receives gas flow from the inlet passage 145, through the valving assembly, and the flow restricting passage 173. The discharge chamber 142 also communicates with the outlet passage 155.

The flow bypass plate 125 includes aspirators 172 and 172′ in the form of passages formed in its disc like portion. Aspirator 172 communicates between the flow passage 173 and the sensing chamber 144. Aspirator 172′ communicates between the discharge chamber 142 and the sensing chamber 144. When the valving assembly 130 is open, gas travels through the restrictive flow passage 173 where its pressure decreases. After the gas exits passage 173, it expands into the discharge chamber 142 and its pressure increases. Thus, the pressure of the gas within flow passage 173 is lower than the pressure of the gas within the discharge chamber 142.

Initially, the gas pressure within the sensing chamber 144 and discharge chamber 142 are substantially equal and the gas pressure within flow aperture 173 is lower than the gas pressure within both chamber 142 and 144. Since gas seeks to travel from a higher to a lower pressure region, the gas within sensing chamber 144 travels through the aspirators 172 and 172′ towards flow aperture 173 and into discharge chamber 144. It should be understood that the aspirators 172 and 172′ may be positioned at any location at or near the low pressure region of flow aperture 173.

As the gas flows from the sensing chamber 142 to the discharge chamber 144, the sensing chamber pressure drops. By virtue of the pressure drop, the regulator spring 114 expands and forces piston 113 to further separate valve plug 160 from valve seat 164. The increased separation of valve plug 160 from valve seat 164 induces greater fluid flow through the valving assembly, thereby increasing the outlet pressure and reducing fluid flow droop.

In addition to the aspirators 172, 172′, spring 114 of the exemplary embodiment also counteracts fluid flow droop caused by the spring effect. In this embodiment spring 114 comprises a vertical stack of non-linear disc springs, e.g., Belleville washers or any other type of non-linear disc spring. By virtue of the geometry and the material properties of the non-linear spring washers, the washers effect a higher outlet pressure at a given valve opening, thereby reducing droop. More particularly, the collective stack of washers of this embodiment has a lower spring rate than a standard helical range spring and applies less force to the topside of diaphragm 120 for a given amount of washer travel, as compared to a standard helical spring. Thus, less change in internal gas pressure is required to overcome the force exerted on the topside of diaphragm 120, and the valving assembly 130 is permitted to open further with less of a drop in pressure.

The diaphragm 120 of the exemplary embodiment is configured to reduce droop caused by the diaphragm effect. As seen in FIG. 1B, the diaphragm is formed with corrugations 121. As the diaphragm is extended toward the valving assembly 130, by the piston 113, the diaphragm flexes and the effective area of the diaphragm decreases, thus, maintaining a more constant outlet pressure. The diaphragm may have any number of corrugations 121. The radii of the corrugations may be, for example, 0.1 inches or any dimension sufficient to produce a non-linear response of the diaphragm. The diaphragm is optionally composed of stainless steel.

The valving assembly 130 is also configured to reduce droop. More particularly, the geometry of the mating surface 168 of valve plug 160 is tailored to facilitate a quick opening flow characteristic. The flow characteristic of a valving assembly is the relationship which exists between the flow through the valving assembly and the travel of the valve plug relative to the valve seat. A “quick opening” flow characteristic is defined by an increasing change in flow rate for a particular translation of the valve plug relative to the valve seat, as compared to a constant change exhibited by a “linear flow characteristic”. In this embodiment, the radius of the revolved mating surface 168 of valve plug 160 may be about 0.1 inches to generate a quick opening flow characteristic.

The free end face of the seat hub 126 of flow bypass plate 125 clamps valve seat 164 on the body member 105 because of the clamping action between the bonnet 111 and collar 119. In contrast, conventional valve seat retainers are typically threadedly coupled to the regulator housing to retain the valve seat in a substantially fixed position. It has been recognized that threads can be a source of virtual leaks or accumulated metallic particles thereby affecting the purity of the gas. Moreover, the use of elastomers in this type of regulator may not be preferred as the elastomers can contain and release harmful impurities into the regulator system. Thus, the valve seat 164 may be composed of a non-outgassing polymeric material such as PTFE, PCTFE, or Vespel® currently sold and distributed by DuPont.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A pressure regulator configured to reduce fluid flow droop comprising:
a regulator housing having an inlet port, an outlet port and a fluid flow passage therebetween;
a valve seat positioned in said fluid flow passage;
a valve plug cooperating with said valve seat to control the flow of a fluid through said fluid flow passage; and
a bypass plate retaining said valve seat in said fluid flow passage, and separating said fluid flow passage from a sensing chamber, said bypass plate including a flow aperture positioned in said flow passage and at least one aspirator providing communication between said flow aperture and said sensing chamber, wherein
said flow aperture is configured to provide a low pressure region relative to the pressure in said fluid flow passage and wherein said at least one aspirator is configured to communicate between said low pressure region and said sensing chamber.

2. The pressure regulator of claim 1 wherein said flow aperture is a flow restricting passage formed in said bypass plate.

3. The pressure regulator of claim 2, wherein said aspirator communicates directly with said flow restricting passage.

4. The pressure regulator of claim 1 wherein said bypass plate is clamped between said regulator housing and a diaphragm.

5. The pressure regulator of claim 4 wherein said diaphragm includes at least one corrugated portion which provides a non-linear translation of said diaphragm relative to a force exerted thereupon.

6. The pressure regulator of claim 4 wherein said bypass plate is threadless and compresses said valve seat in position in said flow passage.

7. The pressure regulator of claim 4 wherein said diaphragm is positioned adjacent said valve plug and wherein said regulator further includes a spring urging said diaphragm in contact with said valve plug to bias said valve plug to an open position to control the flow of fluid through said flow passage.

8. The pressure regulator of claim 7 further comprising an adjusting screw for adjusting the force said spring applies to said diaphragm.

9. The pressure regulator of claim 7 wherein said spring force is non-linear.

10. The pressure regulator of claim 9, wherein said spring is a stack of Belleville washers.

11. The pressure regulator of claim 1 further comprising a plurality of aspirators formed in said bypass plate to reduce droop.

12. The pressure regulator of claim 1 wherein a geometry at a mating interface of said valve plug and said valve seat is configured to facilitate a quick opening flow characteristic.

13. A pressure regulator configured to reduce fluid flow droop comprising:
a regulator housing including an inlet port, an outlet port and a flow passage therebetween;
a valve seat positioned in said fluid flow passage and a valve plug cooperating with said valve seat; and
a bonnet mounted to said regulator housing, a non-linear spring positioned within said bonnet and a diaphragm positioned adjacent said spring and said valve plug, whereby said spring urges said diaphragm to bias said valve plug toward an open position.

14. The pressure regulator of claim 13 wherein said spring comprises a stack of Belleville washers and wherein said regulator further includes a screw operative to adjust the force exerted by said spring on said valve plug.

15. The pressure regulator of claim 14 wherein said diaphragm includes at least one corrugated portion which provides a non-linear translation of said diaphragm relative to said force exerted by said spring.
